(19) United States
(12) Patent Application Publication
(10) Pub. No.: US 2005/0090973 A1
(43) Pub. Date: Apr. 28, 2005

(54) Adaptive analysis technique for planning road layout

(75) Inventors: Jerome Kurtzberg, Yorktown Heights, NY (US); Menachem Levanoni, Poway, CA (US)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 10/695,142

(22) Filed: Oct. 28, 2003

(51) Int. Cl. G01C 21/30

(52) U.S. Cl. 701/208

(57) ABSTRACT

A computer method for enhancing road layout. The method includes the steps of providing a travel database comprising a compendium of individual travel history; providing a road database comprising a compendium of at least one of road location solution, road information, and road diagnostics; and, employing an adaptive analysis technique for interrogating the travel and road databases for generating an output data stream, the output data stream correlating travel history with road layout.

### CROSS REFERENCE TO RELATED APPLICATIONS

This application is related to application Ser. No. 09/604,535 to Levanoni, et al. (IBM Docket YOR920000425US1) filed Jun. 27, 2000; to application Ser. No. 09/612,683 to Levanoni, et al. (IBM Docket YOR920000446US1) filed Jul. 10, 2000; to application Ser. No. 09/633,830 to Levanoni, et al. (IBM Docket YOR920000508US1) filed Aug. 7, 2000; to application Ser. No. 09/696,552 to Levanoni, et al. (IBM Docket YOR920000590US1) filed Oct. 25, 2000; and to application Ser. No. ______ to Levanoni, et al. (IBM Docket YOR920030560US1) filed on even date. Each of these applications is co-pending and commonly assigned.

### BACKGROUND OF THE INVENTION

1. Field of the Invention

This invention relates to methodology and apparatus for utilizing an adaptive analysis technique in the area of road layout.

2. Introduction to the Invention

Adaptive analysis techniques are known and include disparate technologies, including neural networks, which can work to an end of efficiently discovering valuable, non-obvious information from a large collection of data. The data, in turn, may arise in fields ranging from e.g., marketing, finance, manufacturing, or retail.

### SUMMARY OF THE INVENTION

We have now discovered novel methodology for exploiting the advantages inherent generally in adaptive analysis technologies, in the particular field of road layout applications.

Our work proceeds in the following way.

Normally, a road engineer develops a travel database comprising a compendium of travel history—e.g., a travel correlation to geographical locations. Secondly, and independently, the road engineer develops in his mind a road database comprising the road engineer's personal, partial, and subjective knowledge of objective road facts culled from e.g., the marketing literature, the business literature, or input from colleagues or those skilled in the art. Thirdly, the road engineer subjectively correlates in his mind the necessarily incomplete and partial road database, with the travel database, in order to promulgate an individual travel prescribed road layout evaluation and selection.

This three-part approach is part science and part art, and captures one aspect of the problems associated with road layout. However, as suggested above, it is manifestly a subjective paradigm, and therefore open to human vagaries.

We now disclose a novel computer method which can preserve the advantages inherent in the abovementioned approach, while minimizing the incompleteness and attendant subjectivities that otherwise inure in a technique heretofore entirely reserved for human realization.

To this end, in a first aspect of the present invention, we disclose a novel computer method comprising the steps of:
i) providing a travel database comprising a compendium of travel history;
ii) providing a road database comprising a compendium of at least one of road location solutions, road information, and road diagnostics; and
iii) employing an adaptive analysis technique for interrogating said travel and road databases for generating an output data stream, said output data stream correlating travel history with road location solution.

The novel method preferably comprises a further step of updating the step i) travel database, so that it can cumulatively track the travel history as it develops over time. For example, this step i) of updating the travel database may include the results of employing the step iii) adaptive analysis technique. Also, the method may comprise a step of refining an employed adaptive analysis technique in cognizance of pattern changes embedded in each database as a consequence of current results, and updating the travel database.

The novel method preferably comprises a further step of updating the step ii) road database, so that it can cumulatively track an ever increasing and developing technical road management literature. For example, this step ii) of updating the road database may include the effects of employing an adaptive analysis technique on the travel database. Also, the method may comprise a step of refining an employed adaptive analysis technique in cognizance of pattern changes embedded in each database as a consequence of road geography results, and updating the road database.

The novel method may employ advantageously a wide array of step iii) adaptive analysis techniques for interrogating the travel and road databases for generating an output data stream, which output data stream correlates travel history with road location solution. For example, the adaptive analysis technique may comprise inter alia employment of the following functions for producing output data: classification-neural, classification-tree, clustering-geoographic, clustering-neural, factor analysis, or principal component analysis, or expert systems.

In a second aspect of the present invention, we disclose a program storage device readable by machine to perform method steps for providing an interactive road management database, the method comprising the steps of:
i) providing a travel database comprising a compendium of individual travel history;
ii) providing a road database comprising a compendium of at least one of road location solution, road information, and road diagnostics; and
iii) employing an adaptive analysis technique for interrogating said travel and road databases for generating an output data stream, said output data stream correlating travel history with road location solution.

In a third aspect of the present invention, we disclose a computer comprising:
i) means for inputting a travel database comprising a compendium of individual travel history;
ii) means for inputting a road database comprising a compendium of at least one of road location solution, road information, and road diagnostics;
iii) means for employing an adaptive analysis technique for interrogating said travel and road databases; and
iv) means for generating an output data stream, said output data stream correlating travel history with road location solution.

We have now summarized the invention in several of its aspects or manifestations. It may be observed, in sharp contrast with the prior art discussed above comprising the three-part subjective paradigm approach to the problem of road layout, that the summarized invention utilizes inter alia, the technique of adaptive analysis.

We now point out, firstly, that the technique of adaptive analysis is of such complexity and utility, that as a technique, in and of itself, it cannot be used in any way as an available candidate solution for road layout, to the extent that the problem of road layout is only approached within the realm of the human-subjective solution to road layout. Moreover, to the extent that the present invention uses computer techniques including e.g., adaptive analysis techniques, to an end of solving a problem of road layout, it is not in general obvious, within the nominal context of the problem and the technique of adaptive analysis, how they are in fact to be brought into relationship in order to provide a pragmatic solution to the problem of road layout. It is, rather, an aspect of the novelty and unobviousness of the present invention that it discloses, on the one hand, the possibility for using the technique of adaptive analysis within the context of road layout, and, moreover, on the other hand, discloses illustrative methodology that is required to in fact pragmatically bring the technique of adaptive analysis to bear on the actuality of solving the problem of road layout.

### BRIEF DESCRIPTION OF THE DRAWING

The invention is illustrated in the accompanying drawing, in which

FIG. 1 provides an illustrative flowchart comprehending overall realization of the method of the present invention;

FIG. 2 provides an illustrative flowchart of details comprehended in the FIG. 1 flowchart;

FIG. 3 shows a neural network that may be used in realization of the FIGS. 1 and 2 adaptive analysis algorithm; and

FIG. 4 shows further illustrative refinements of the FIG. 3 neural network.

### DETAILED DESCRIPTION OF THE PRESENT INVENTION

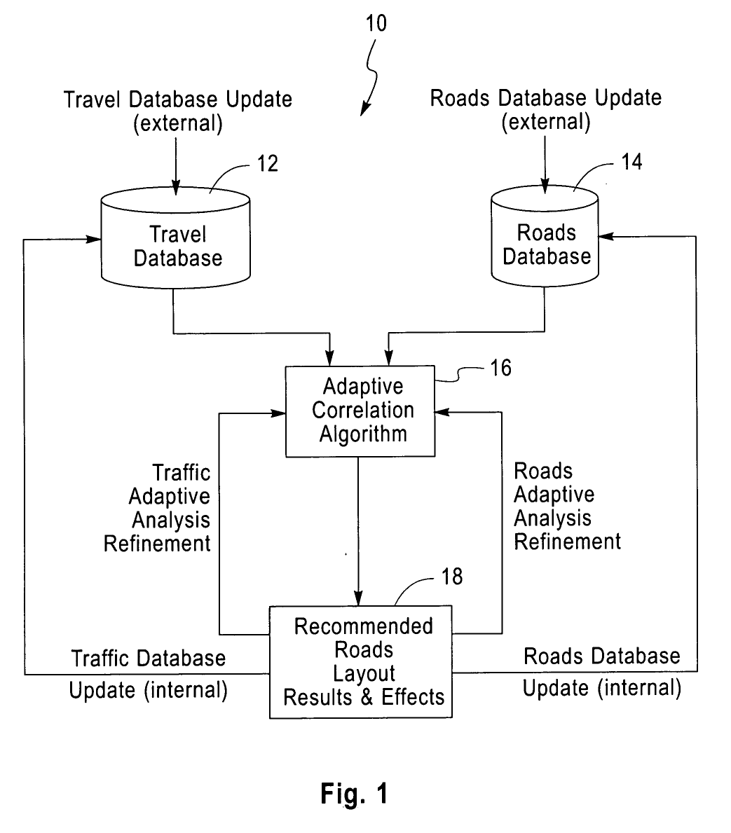

The detailed description of the present invention proceeds by tracing through three quintessential method steps, summarized above, that fairly capture the invention in all its sundry aspects. To this end, attention is directed to the flowcharts and neural networks of FIGS. 1 through 4, which can provide enablement of the three method steps.

FIG. 1, numerals 10-18, illustratively captures the overall spirit of the present invention. In particular, the FIG. 1 flowchart (10) shows a travel database (12) comprising a compendium of individual travel history, and a road database (14) comprising a compendium of at least one of road location solution, road information, and road diagnostics. Those skilled in the art will have no difficulty, having regard to their own knowledge and this disclosure, in creating or updating the databases (12,14) e.g., conventional techniques can be used to this end. FIG. 1 also shows the outputs of the travel database (12) and road database (14) input to an adaptive analysis condition algorithm box (16). The adaptive analysis algorithm can interrogate the information captured and/or updated in the travel and road databases (12,14), and can generate an output data stream (18) correlating travel history with road location solution. Note that the output (18) of the adaptive analysis algorithm can be advantageously, self-reflexively, fed as a subsequent input to at least one of the travel database (12), the road database (14), and the adaptive analysis correlation algorithm (16).

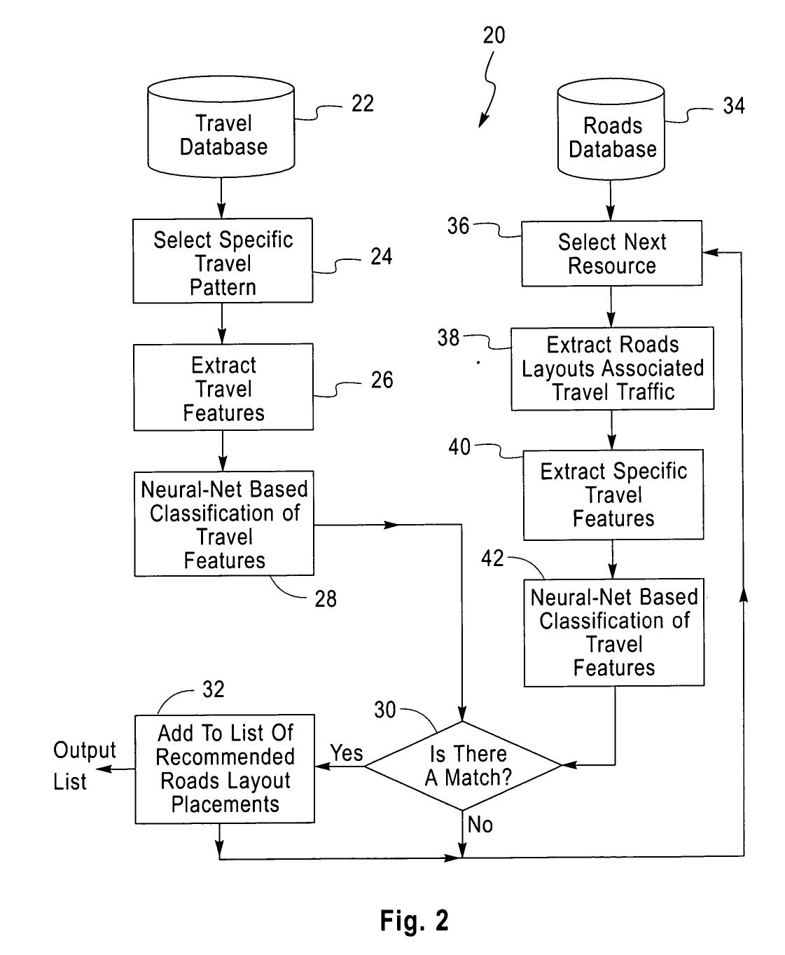

Attention is now directed to FIG. 2, which provides a flowchart (20-42) that recapitulates some of the FIG. 1 flowchart information, but adds particulars on the immediate correlation functionalities required of the adaptive analysis correlation algorithm. For illustrative purposes, FIG. 2 comprehends the adaptive analysis correlation algorithm as a neural-net based classification of travel features, e.g., wherein a travel feature for say, Monday morning traffic, may include location information such as geography, demographics, current local road information, expected travel by week, etc.

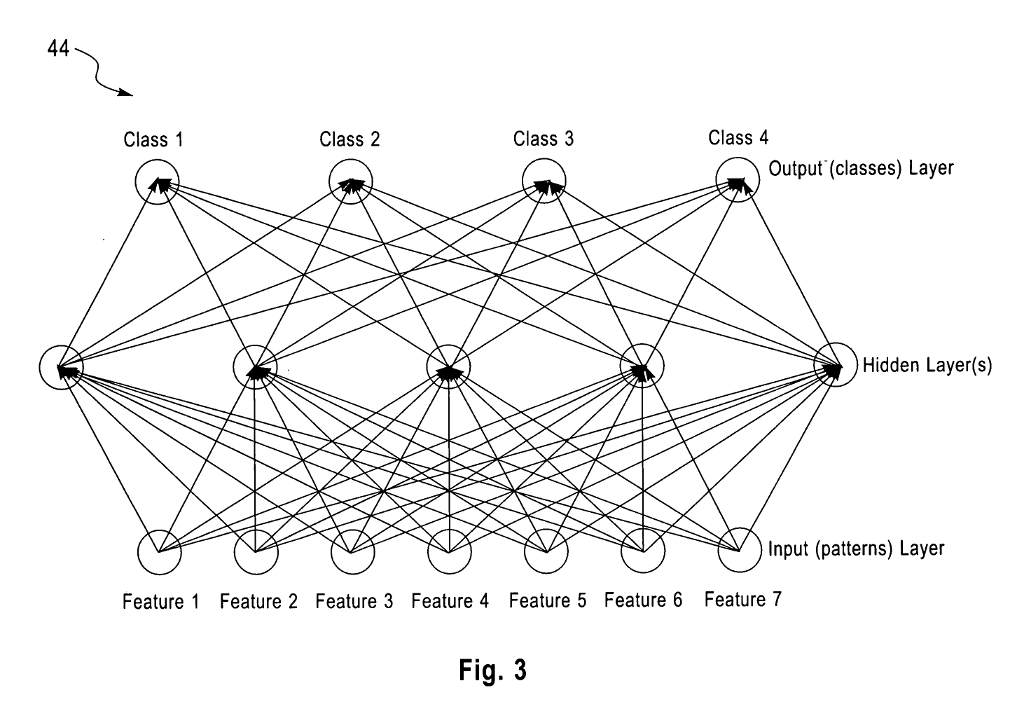

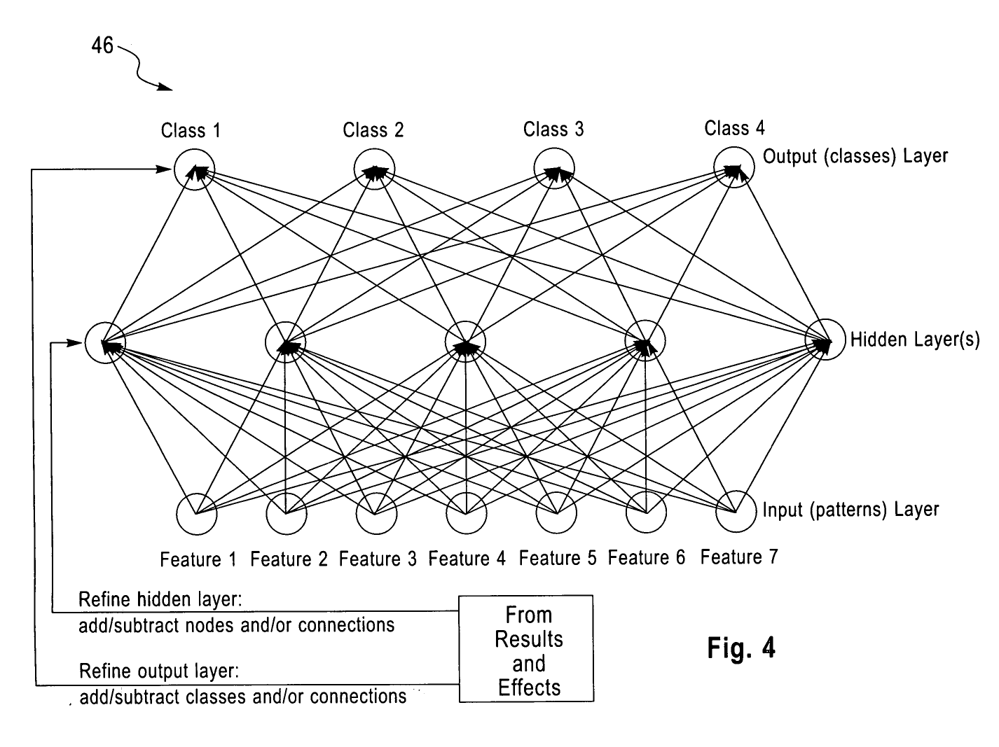

FIG. 3, in turn, shows a neural-net (44) that may be used in realization of the FIGS. 1 and 2 adaptive analysis correlation algorithm. Note the reference to classes which represent classification of input features. The FIG. 3 neural-net (44) in turn, may be advantageously refined, as shown in the FIG. 4 neural-net (46), to capture the self-reflexive capabilities of the present invention, as elaborated above.

1. A computer method comprising the steps of:
i) providing a travel database comprising a compendium of individual travel history;
ii) providing a road database comprising a compendium of at least one of road location solution, road information, and road diagnostics; and
iii) employing an adaptive analysis technique for interrogating said travel and road databases for generating an output data stream, said output data stream correlating travel history with road location solution.

2. A method according to claim 1, comprising a step of updating the travel database.

3. A method according to claim 2, comprising a step of updating the travel database so that it includes the results of employing an adaptive analysis technique.

4. A method according to claim 1, comprising a step of updating the road database.

5. A method according to claim 4, comprising a step of updating the road database so that it includes the effects of employing an adaptive analysis technique on the travel database.

6. A method according to claim 2, comprising a step of refining the employed adaptive analysis technique in cognizance of pattern changes embedded in each database as a consequence of updating the travel database.

7. A method according to claim 4, comprising a step of refining the employed adaptive analysis technique in cognizance of pattern changes embedded in each database as a consequence of updating the road database.

8. A method according to claim 1, comprising a step of employing a neural network as the adaptive analysis technique.

9. A program storage device readable by machine, tangibly embodying a program of instructions executable by the machine to perform method steps for providing an interactive road management database, the method comprising the steps of:
i) providing a travel database comprising a compendium of individual travel history;
ii) providing a road database comprising a compendium of at least one of road layout solution, road information, and road diagnostics; and
iii) employing an adaptive analysis technique for interrogating said travel and road databases for generating an output data stream, said output data stream correlating travel history with road location solution.

10. A computer comprising:
i) means for inputting a travel database comprising a compendium of individual travel history;
ii) means for inputting a road database comprising a compendium of at least one of road management solution, road information, and road diagnostics;
iii) means for employing an adaptive analysis technique for interrogating said travel and road databases; and
iv) means for generating an output data stream, said output data stream correlating travel history with road location solution.
